(19) United States
(12) Patent Application Publication
(10) Pub. No.: US 2017/0142615 A1
(43) Pub. Date: May 18, 2017

(54) METHOD AND APPARATUS FOR COMMUNICATING ADDITIONAL NARROWBAND TRAFFIC OVER AN EXISTING 4G/LTE NETWORK

(71) Applicant: Prakash Bhalerao, Cupertino, CA (US)

(72) Inventor: Prakash Bhalerao, Cupertino, CA (US)

(21) Appl. No.: 15/214,059

(22) Filed: Jul. 19, 2016

Related U.S. Application Data
(60) Provisional application No. 62/256,863, filed on Nov. 18, 2015.

(51) Int. Cl. H04W 28/10; H04W 4/02; H04B 17/10; H04L 27/26; H04L 29/08

(52) U.S. Cl. CPC H04W 28/10; H04L 27/2607; H04L 67/10; H04B 17/104; H04W 4/02

(57) ABSTRACT

Systems and techniques for communicating additional narrowband non-bursty data traffic in a 4G/LTE network are described. Specifically, existing data traffic can be communicated in user symbols that are separated by guard symbols, and the additional narrowband non-bursty data traffic can be communicated in the guard symbols. In some embodiments, the additional narrowband non-bursty data traffic is communicated over guard bands that separate frequency bands that are allocated to different carriers.

### RELATED APPLICATION

This application claims benefit of U.S. Provisional Application Ser. No. 62/256,863, filed on 18 Nov. 2015, by the same inventor, having attorney docket no. BHAL15-1001P, the contents of which are herein incorporated by reference in their entirety.

### BACKGROUND

Technical Field

This disclosure relates to communication networks. More specifically, this disclosure relates to methods and apparatuses for communicating additional narrowband traffic over an existing 4G (fourth generation)/LTE (long-term evolution) network.

Related Art

Imagine a future in which tens of billions of devices and sensors are embedded throughout the world and are accessible through the Internet: connected home appliances and devices (televisions, refrigerators, air conditioner, heaters, water sprinklers, security systems, etc.), connected cars, connected logistics, connected clothing, etc. This is the vision behind the internet of things (IoT) and is this futuristic vision may be realized in the not-so-distant future. Initially the traffic generated by IoT devices will be small. But, over time, IoT devices are expected to eclipse today's highest traffic contributors to the Internet, such as audio and video content. It is clearly economically unfeasible to perform a forklift upgrade of the existing communication infrastructure to accommodate the expected deluge of IoT traffic. Therefore, what are needed are techniques and systems to efficiently and economically carry IoT device traffic in existing communication networks.

### SUMMARY

Some embodiments described herein feature systems and techniques for communicating additional narrowband non-bursty data traffic in a 4G/LTE network. Specifically, the embodiments can communicate existing data traffic in user symbols that are separated by guard symbols, and can communicate the additional narrowband non-bursty data traffic in the guard symbols. Note that the guard symbols are used in the 4G/LTE network to prevent corruption of the user symbols by multipath reflections. In some embodiments, the resources for communicating the additional narrowband non-bursty data traffic are allocated using a second protocol stack that is distinct from a first protocol stack that is used for allocating resources for communicating the existing data traffic.

In some embodiments, communicating the additional narrowband non-bursty data traffic data in the guard symbols comprises: (1) computing an estimate of a multipath delay in a cell that includes a user equipment (UE) and an evolved Node B (eNB); (2) determining a size and a location of a time slot in the guard symbol based on the estimate of the multipath delay; and (3) communicating the additional narrowband non-bursty data traffic data in a time slot having the determined size and location in the guard symbols.

In some embodiments, the UE can be an internet of things (IoT) device. In some embodiments, the IoT device periodically sends sensor data to the eNB.

Some embodiments described herein feature a UE or an eNB for communicating additional narrowband non-bursty data traffic in a 4G/LTE network. The UE or eNB can comprise (1) circuitry to communicate existing data traffic in user symbols that are separated by guard symbols, and (2) circuitry to communicate the additional narrowband non-bursty data traffic in the guard symbols. The circuitry to communicate existing data traffic in user symbols that are separated by guard symbols can comprise (1) a DFT circuit to encode and decode the existing data traffic to and from, respectively, the user symbols; (2) a cyclic prefix circuit for creating the guard symbols; (3) an RF transceiver; and (4) an antenna. The circuitry to communicate the additional narrowband non-bursty data traffic in the guard symbols can comprise a narrowband data circuit to (1) insert the narrowband non-bursty data traffic into the guard symbols and (2) extract the narrowband non-bursty data traffic from the guard symbols; and a processor to process control traffic communicated over the guard symbols by using a narrowband data protocol stack.

Specifically, in an eNB, the processor can be configured to: (1) compute an estimate of a multipath delay in a cell that includes a UE and the eNB; (2) determine a size and a location of a time slot in the guard symbols based on the estimate of the multipath delay; and (3) communicate the determined size and location of the time slot to the UE.

### BRIEF DESCRIPTION OF THE FIGURES

FIG. 1A illustrates an LTE frame in accordance with some embodiments described herein.

FIG. 1B illustrates a guard symbol in accordance with some embodiments described herein.

FIG. 2A illustrates how the guard subcarriers can be used for narrowband data transmission in accordance with some embodiments described herein.

FIG. 2B illustrates an approach to accommodate IoT traffic in accordance with some embodiments described herein.

FIG. 3 illustrates how a narrowband radio resource can be allocated to an IoT UE in accordance with some embodiments described herein.

FIG. 4A illustrates how UEs communicate in an LTE network.

FIG. 4B illustrates how IoT UEs can communicate in an LTE network in accordance with some embodiments described herein.

FIG. 5A illustrates a transmitting mechanism in accordance with some embodiments described herein.

FIG. 5B illustrates a receiving mechanism in accordance with some embodiments described herein.

FIG. 6 illustrates how multipath delay can be computed in accordance with some embodiments described herein.

FIG. 7 illustrates an approach for carrying uplink and downlink traffic in accordance with some embodiments described herein.

FIG. 8 illustrates an approach for carrying uplink and downlink traffic in accordance with some embodiments described herein.

FIG. 9 illustrates a process for communicating additional narrowband non-bursty data traffic in a 4G/LTE network in accordance with some embodiments described herein.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein. In this disclosure, when the term “and/or” is used with a list of entities, it refers to all possible combinations of the list of entities. For example, the phrase “X, Y, and/or Z” covers the following embodiments: (1) only X; (2) only Y; (3) only Z; (4) X and Y; (5) X and Z; (6) Y and Z; and (7) X, Y, and Z.

### 4G/LTE Network Infrastructure

4G/LTE is a wireless communication standard that is based on the GSM/EDGE and UMTS/HSPA network technologies, and is designed to increase data communication capacity and speed for mobile phones and data terminals. LTE is the natural upgrade path for telecommunication carriers with existing GSM/UMTS networks and CDMA2000 networks.

Telecommunication carriers across the world have invested enormous amounts of resources to make their existing wireless data networks 4G/LTE compliant. Therefore, the existing 4G/LTE infrastructure is an obvious choice for carrying IoT device traffic. Unfortunately, this network is poorly suited for carrying IoT traffic. Specifically, current 4G/LTE networks are well suited for traffic that has the following key characteristics: (1) high bandwidth, bursty traffic, with sufficiently long quiescent period, and (2) predominantly downlink traffic, where downlink traffic means traffic from the Network to the User Equipment (UE).

Today, majority of the 4G/LTE devices are smartphones. Users use these devices to access the network whenever required. When users use the device, they require a high data rate (e.g., for streaming a high definition YouTube video). However, once the short use period is over, these devices typically become quiescent for a relatively long period of time before being used again. Also, the downlink traffic is much more than uplink traffic. These two aspect of the traffic—(1) short durations of high bandwidth traffic separated by relatively longer quiescent durations and (2) much larger downlink traffic than uplink traffic—are critically important to enable the current 4G/LTE network infrastructure to handle the traffic demand.

In existing 4G/LTE networks, the radio resources are allocated to the UE devices on “as needed” basis. Long period of “quiescent” nature allows operators to keep a UE “connected” to the network without allocating the radio resource for transmission. This, in turn, allows operators to oversubscribe their customer base to generate much higher revenue from given number of finite radio resources. To take a specific example, suppose a radio tower eNB-1 has 100 radio resources. The term “eNB” is an abbreviation of “Evolved Node B” or “E-UTRAN Node B” which is the evolution of the element called “Node B” in UTRA or of UMTS. An eNB is a device that wirelessly communicates with the UE (e.g., a mobile phone), and therefore corresponds to a base transceiver station in GSM networks. Since the eNB-1 has 100 radio resources, it means that at any given time 100 UE devices can connect to the Internet using this eNB's radio resources. However, given the UE behavior pattern described above, let us assume that operator can oversubscribe by 500%. This way the operator allows 500 UE devices to be on the eNB, fully aware that only 100 of them are expected to transmit at any given time. This is perfectly practical and users don't see any degradation in service.

However, the behavior of UE devices is expected to change drastically as IoT devices become increasingly popular. In particular, the oversubscription model described above—which is fundamental to all carriers—will no longer be possible. To understand why, let us understand how the behavior of IoT devices is significantly different from the behavior of smartphones. Characteristics of IoT traffic include the following: (1) low bandwidth and non-bursty traffic, (2) devices may not go quiescent for long periods of time, and (3) predominantly uplink traffic (i.e., the traffic from the UE to the Network is significantly more than the traffic from the Network to the UE).

As an example, consider an IoT device that is performing gas tank monitoring. This device may need to send a status update every 5 seconds. The amount of data transfer is minuscule, but it is sent continuously, i.e., unlike a smartphone there is no quiescent period. Now, consider the impact this type of traffic behavior can have on the oversubscription example that was discussed above in which an eNB had 100 radio resources. Suppose 40 IoT devices attach to the eNB. These IoT devices will never give up the radio resources. Therefore, the network operator (e.g., a telecommunication carrier) is left with 60 radio resources that can be over-subscribed. Thus the network operator can only service 300 normal users (based on the same 500% oversubscription ratio as before)+40 IoT users, which represents a loss of 160 users, which potentially translates to a 32% loss in revenue. Moreover, the revenue will continue to decline as the number of IoT devices increase. Telecommunication carriers will not be able to survive such a drastic loss in revenue.

### Communicating Narrowband Traffic on a 4G/LTE Network Infrastructure

Some embodiments described herein carve out data transmission channels from within the LTE bands in such a way that traffic characteristics of these channels match exactly to the IoT traffic. In some embodiments, the guard symbols are used in such a manner that the network can be optimized for the IoT traffic characteristics.

An LTE transmission channel has several guard symbols between the user symbols. The user symbols carry information between the Network and UE. The guard symbols are used to prevent corruption of the user symbols by multipath reflections. Some embodiments described herein use a part of the guard symbol to transmit a narrowband signal such that there is no impact on the existing LTE traffic, and at the same time it allows low bandwidth traffic (e.g., IoT traffic) to be sent.

Specifically, in some embodiments, a small time domain slot can be modulated which is centered in the guard symbol. In other embodiments, a non-centered spot within the guard band can be used if it results in better performance.

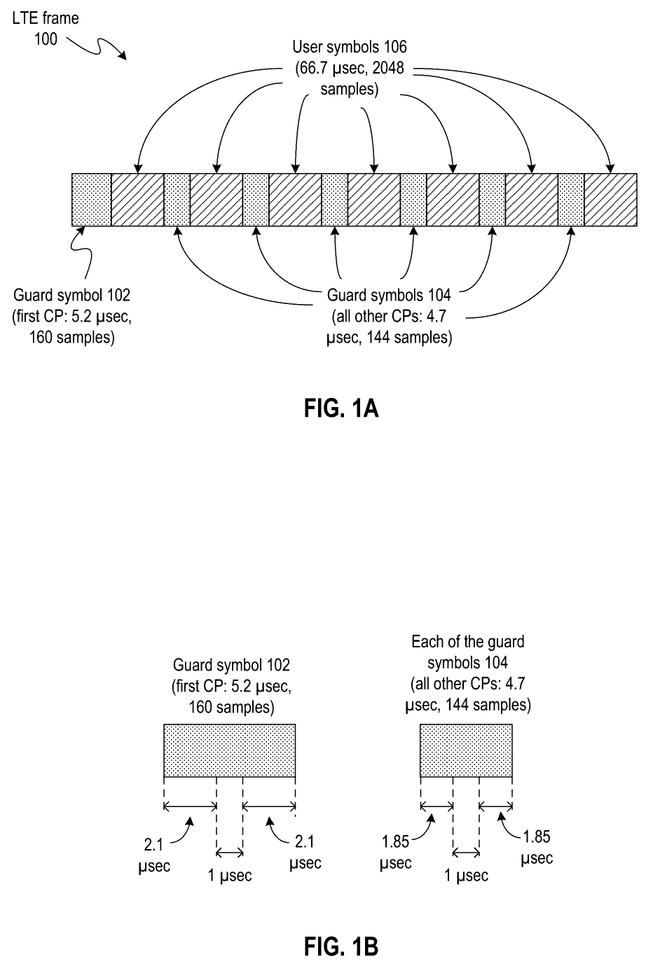

FIG. 1A illustrates an LTE frame in accordance with some embodiments described herein. Note that FIG. 1A has not been drawn to scale for ease of discourse. FIG. 1A shows a typical LTE frame 100 that contains 7 cyclic prefixes (CP) and 7 user symbols 106. The first cyclic prefix—shown as guard symbol 102 in FIG. 1A—is a little longer in duration. The first guard symbol 102 and the other 6 shorter guard symbols 104 separate the 7 user symbols 106 in the time domain. Note that the guard symbols serve an important purpose in LTE: they make the user symbols insensitive to time dispersion.

FIG. 1B illustrates a guard symbol in accordance with some embodiments described herein. As shown in FIG. 1B, a 1 microsecond worth of transmission time can be obtained from each prefix. For the sake of simplicity, 1 microsecond worth of time is “stolen” from every prefix even though the first prefix is a little longer. A suitable encoding can be chosen for transmission to reduce UE power and computational needs, rather than obtaining more bandwidth. In general, a reliable, low power, and low bandwidth-encoding scheme is preferred over a computationally demanding encoding. In FIG. 1B, only 1 microsecond time slot is shown for illustration purposes and is not intended to limit the scope of the disclosed embodiments. Specifically, the network may “steal” a shorter or longer time slot from the guard symbols for carrying IoT traffic. Additionally, the “stolen” time slot is shown at the center of the guard symbol. However, the time slot can generally be located anywhere in the guard symbol. IoT traffic can thus be sent on both the downlink and the uplink by stealing a time slot in guard symbols.

Network operators never use the full LTE band they purchase. Each full band consists of several subcarriers. Typically 12 subcarriers form a single Resource Block in LTE. Certain number of subcarriers are left as guard subcarriers. The following table shows an example of downlink subcarrier usage.

| | Channel Bandwidth in MHz | | | | | |
|---|---|---|---|---|---|---|
| | 1.25 | 2.5 | 5 | 10 | 15 | 20 |
| Occupied Sub Carriers | 76 | 151 | 301 | 601 | 901 | 1201 |
| Guard Sub Carriers | 52 | 105 | 211 | 423 | 635 | 847 |

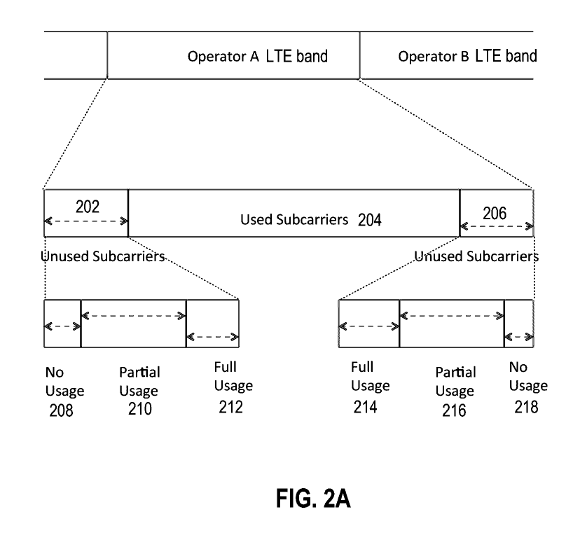

Some embodiments described herein use the guard subcarriers for narrowband data transmission. FIG. 2A illustrates how the guard subcarriers can be used for narrowband data transmission in accordance with some embodiments described herein. In FIG. 2A, there are two LTE operators operating in the same geographical area. The allocated LTE bands of operator A and operator B are adjacent to each other in the frequency spectrum. Note that there are unused LTE subcarriers 202 and 206 on each side of the used subcarriers 204 that act as buffers. Some embodiments described herein divide the unused subcarriers 202 and 204 into three sections: full usage sections 212 and 214, partial usage sections 210 and 216, and no usage sections 208 and 218.

In some embodiments described herein, the full usage sections 212 and 214 can be divided into 1 microsecond transmission channels that are packed as closely as possible. Since there are no symbols to be transmitted in this frequency band, the 1 microsecond transmission channels can be packed in a much dense fashion. The partial usage sections 210 and 216 can also be divided into 1 microsecond transmission channels, but these channels can be packed relatively sparsely when compared with the full usage sections 212 and 214. The no usage sections 208 and 218 can be left untouched, i.e., this frequency ranges is not used for transmitting the additional low-bandwidth traffic (e.g., IoT traffic).

The sizes of these three sections can be decided at deployment time and can be changed dynamically via signaling based on traffic patterns, usage patterns, time of day etc. In general, embodiments described herein can reduce the packing density as we move closer to the edge of the LTE band to reduce the risk of interference with the LTE band of the adjacent carrier. If there is no carrier operating in the adjoining frequency band, then the full usage sections 212 and 214 can use all of the guard subcarriers. Specifically, some embodiments can measure the energy of the adjoining LTE band. If the adjoining LTE band has no energy, then that would indicate that the adjoining band is unused. In this case, full usage sections 212 and 214 can use all of the guard subcarriers.

In some embodiments, IoT traffic can be accommodated by carving out a set of Resource Blocks or certain subcarriers for IoT devices. This would allow carriers to carve out several thousands of narrowband channels that are dedicated for IoT devices. FIG. 2B illustrates an approach to accommodate IoT traffic in accordance with some embodiments described herein. Portion 250 of used subcarriers can be carved out for IoT purposes. While this approach reduces the total bandwidth available for non-IoT users, it has advantage that the IoT devices will not take up valuable full LTE channels. The IoT devices will have what they need, and so do non-IoT devices.

As explained above, an LTE network reallocates Radio Resources as the UE goes quiescent. This is allows operators to oversubscribe their user base. A UE will request for radio resources when necessary. Network operators depend on efficient management of radio resources in order to generate revenue.

However, this radio resource management has disadvantages when IoT devices are used in an LTE network. In a “normal” radio resource allocation scheme, an IoT device will typically never give up the radio resource. But the channel it is holding on is a full LTE Channel, capable of delivering a much greater data rate than required by the IoT device.

In some embodiments described herein, a section of IoT devices can be provided with guard-band LTE resources for a lot longer duration. For example, the network may grant the radio resources for 24 hours. In other words, an IoT UE will re-request the Radio Resources after a period of 24 hours. Once a Radio Resource (which is located in the guard band as described above) is allocated to an IoT device, the IoT device can use it exclusively for 24 hours.

Specifically, in some embodiments, a section of IoT UEs can be given this privilege based on their SLA. This approach has the advantage of simplifying the UE hardware, and can increase the battery life. It is expected that a typical IoT customer would much prefer to pay extra money for this SLA than sending someone out to replace UE battery.

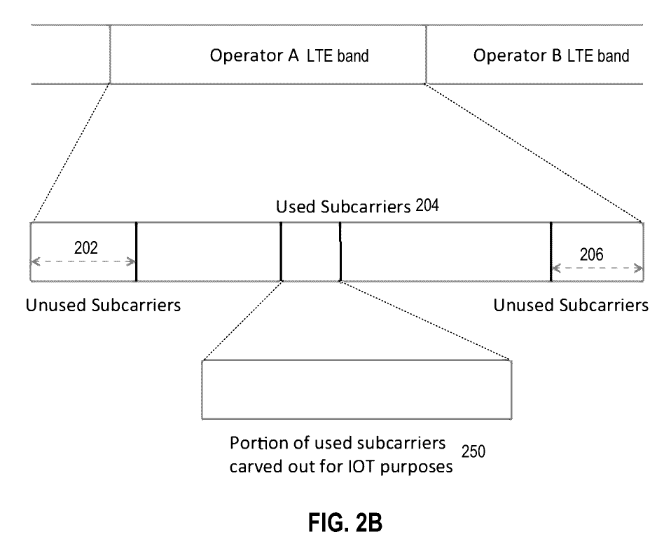

FIG. 3 illustrates how a narrowband radio resource can be allocated to an IoT UE in accordance with some embodiments described herein. An IoT UE can send message 302 to the Network to register with the network. Network can send message 304 back to the UE in response, thereby authenticating the Network with the UE. UE can authenticate its SLA with the Network by sending message 306, and receiving message 308 in response. Finally, the Network can send message 310 to the UE, thereby allocating a narrowband (guard band) radio resource for a long duration, e.g., 24 hours. In this manner, by pre-allocating the guard-band radio resources for a longer duration the network minimizes the number of radio resource reservation requests, which has the following advantages (1) simpler UE hardware/software, enabling much longer battery life, and (2) additional revenue generation based on SLA.

This is possible because some embodiments described herein allow a large number of narrowband (guard band) channels to be created from existing LTE infrastructure. These channels, or radio resources, can be allocated on semi-permanent basis. Optionally a UE can be given more than one narrowband radio resources if needed.

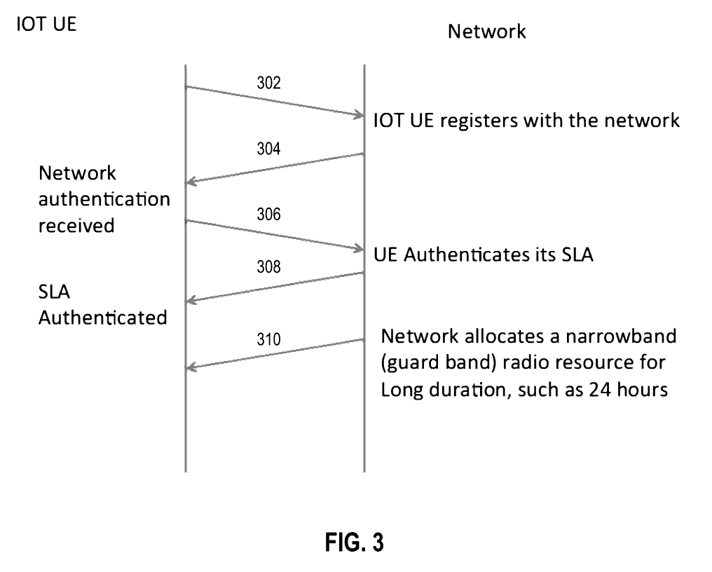

FIG. 4A illustrates how UEs communicate in an LTE network. Specifically, FIG. 4A illustrates some of the important pieces of connection establishment procedure when a UE tries to get on LTE network the first time. UE uses a shared channel to inform the network about its presence (msg1). The Network responds by assigning temporary radio resource and few other parameters such as path delay compensation value etc. (msg2). UE makes a request using this information (msg3), upon which network responds with a Contention Resolution.

FIG. 4B illustrates how IoT UEs can communicate in an LTE network in accordance with some embodiments described herein. Specifically, FIG. 4B illustrates how the initial message exchange is modified so that narrowband IoT devices are identified and a long duration radio resource is allocated. Note that msg1 and msg2 remain exactly same as the existing approach (e.g., as shown in FIG. 4A). However, msg3 in FIG. 4A is replaced by msg5 shown in FIG. 4B, which differs from msg3 as follows: (1) the establishment cause is a new field that identifies the device as narrowband IoT device, and (2) the device also sends information about its traffic type. Specifically, the device can specify the following information about its traffic type: (1) the application's bandwidth requirement, and (2) the application's network access parameters (e.g. a gas pressure meter may specify that it will send pressure reading every 5 seconds, a home electricity meter reader may specify that it will send reading once every week, etc.). Based on this new msg5 information, the network can determine its next action. In particular, the action may be one of the following: (1) allocate a permanent radio request control (RRC) channel that need not be re-requested for long period of time, such as 24 hours if application warrants (and SLA matches), e.g., for the above-described gas pressure meter example; (2) allocate an RRC channel that will be taken away after few seconds of usage (for example 10 seconds), e.g., for the above-described home electricity meter reader example; or (3) deny the UE's request if SLA does not match, or there are no free IoT channels.

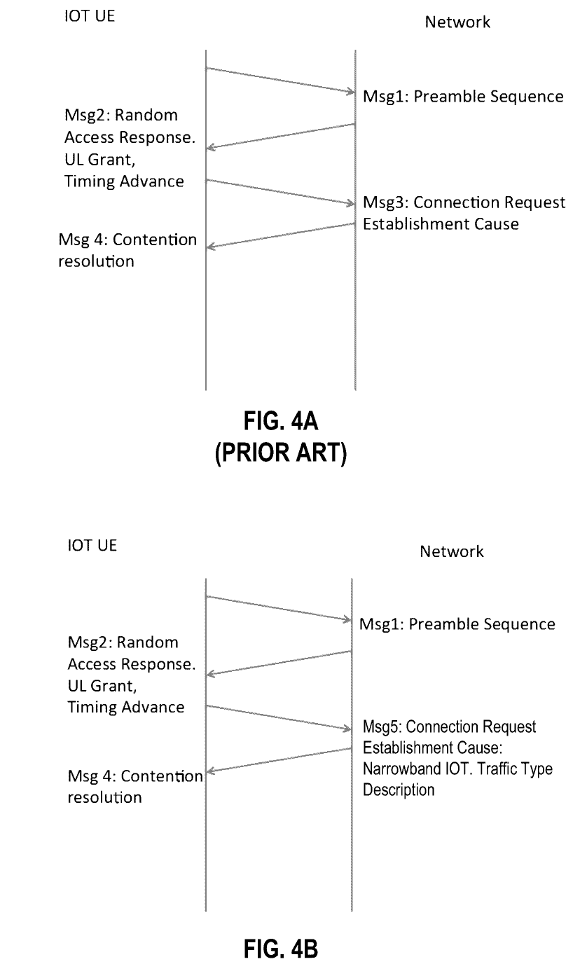

FIG. 5A illustrates a transmitting mechanism in accordance with some embodiments described herein. The user data signal is encoded using an N-point discrete Fourier transform (DFT) circuitry 502. The narrowband data protocol stack 520 provides the additional data (e.g., from an IoT device) that needs to be communicated using the narrowband channel. Circuitry 518 then encodes the data and provides it to circuitry 504. Next, cyclic prefix and pulse shaping, and narrowband data insertion is performed by circuitry 504, and the resulting signal is transmitted by radio frequency (RF) circuitry 506 via antenna 508.

FIG. 5B illustrates a receiving mechanism in accordance with some embodiments described herein. The wireless signal that was transmitted through antenna 508 can be received by RF circuitry 512 via antenna 510. Next, the cyclic prefix can be removed by circuitry 514, and the resulting signal can be provided to N-point DFT circuitry 516. Note that the Cyclic Prefix addition is a step right before the digital signal is converted to analog for RF transmission on transmit side. Naturally Cyclic Prefix removal is the first step after the received RF signal is converted from analog to digital format on receive side. The output of N-point DFT circuitry 516 is the received data signal which can be processed further. Circuitry 522 can then extract the “discarded” Cyclic Prefix, and provide the narrowband data encoded in the “discarded” Cyclic Prefix to the narrowband data protocol stack 524. In this manner, narrowband data protocol stacks 520 and 524 can provide a peer-to-peer narrowband communication channel between an IoT device and the network.

As shown in FIGS. 5A and 5B, embodiments described herein can be implemented by adding a few new components to the existing data processing circuitry. Moreover, a software protocol stack that is completely separate from the 4G/LTE protocol stack can be used to process the narrowband data. Based on the above disclosure, it is clear that embodiments described herein do not require a forklift upgrade for the existing 4G/LTE network and can seamlessly extend the existing 4G/LTE infrastructure to support narrowband traffic. Specifically, once the additional circuitry for inserting and removing the narrowband data is implemented, and a separate software stack is implemented to process the communication messages that are exchanged over the narrowband channel, the rest of the 4G/LTE infrastructure can continue to operate as-is without any disruptions.

Some embodiments feature a UE or an eNB for communicating additional narrowband non-bursty data traffic in a 4G/LTE network. The UE or eNB can comprise (1) circuitry to communicate existing data traffic in user symbols that are separated by guard symbols, and (2) circuitry to communicate the additional narrowband non-bursty data traffic in the guard symbols. The circuitry to communicate existing data traffic in user symbols that are separated by guard symbols can comprise (1) a DFT circuit to encode and decode the existing data traffic to and from, respectively, the user symbols; (2) a cyclic prefix circuit for creating the guard symbols; (3) an RF transceiver; and (4) an antenna.

In some embodiments, the circuitry to communicate the additional narrowband non-bursty data traffic in the guard symbols can comprise a narrowband data circuit to (1) insert the narrowband non-bursty data traffic into the guard symbols and (2) extract the narrowband non-bursty data traffic from the guard symbols; and a processor to process control traffic communicated over the guard symbols by using a narrowband data protocol stack.

In some embodiments, the circuitry to communicate the additional narrowband non-bursty data traffic in the guard symbols can comprise (1) narrowband data insertion and extraction circuit to encode and decode the narrowband non-bursty data traffic to and from, respectively, the guard symbols, wherein the cyclic prefix circuit further comprises inserting the encoded narrowband non-bursty data traffic in the guard symbols; and (2) a processor executing a narrowband data protocol stack for processing control traffic communicated over the guard symbols.

In an eNB, the processor executing the narrowband data protocol stack can be configured to: (1) compute an estimate of a multipath delay in a cell that includes a UE and the eNB; (2) determine a size and a location of a time slot in the guard symbols based on the estimate of the multipath delay; and (3) communicate the determined size and location of the time slot to the UE.

FIG. 1B illustrated how a small time slot in the cyclic prefixes can be used to transmit narrowband IoT traffic. As shown in FIG. 1B, the time slot can be inserted at the center of the cyclic prefix. In some embodiments, the position of the time slot can be determined dynamically within the LTE network.

In existing LTE networks, the Cyclic Prefix is filled up using the last section of the user symbol. The typical size of the cyclic prefix can address multipath delay up to 1.4 km. However, in most installations, the multipath delay is much smaller. Therefore, in some embodiments described herein, the eNB can optimally position the “stolen” timeslot within cyclic prefix if the eNB knows the network multipath delay. In some embodiments, the eNB can be given the network multipath delay, and in other embodiments, the eNB can compute and estimate of the multipath delay. The following paragraphs discuss (1) how the eNB can estimate/calculate multipath delay in a cell on ongoing basis, (2) how the eNB can position the “stolen time slot” within cyclic prefix based on the estimated multipath delay, and (3) how the eNB can inform the narrowband IoT devices about exact time slot position in cyclic prefix that the IoT devices are supposed to use.

In some embodiments, the eNBs can rely on LTE devices to calculate the multipath delay, and to report it back to the eNB. Specifically, in some embodiments, the narrowband IoT devices merely provide raw sensory data to the eNB, and the eNB uses the data to compute the multipath delay. However, the IoT devices themselves do not perform the multipath delay estimation.

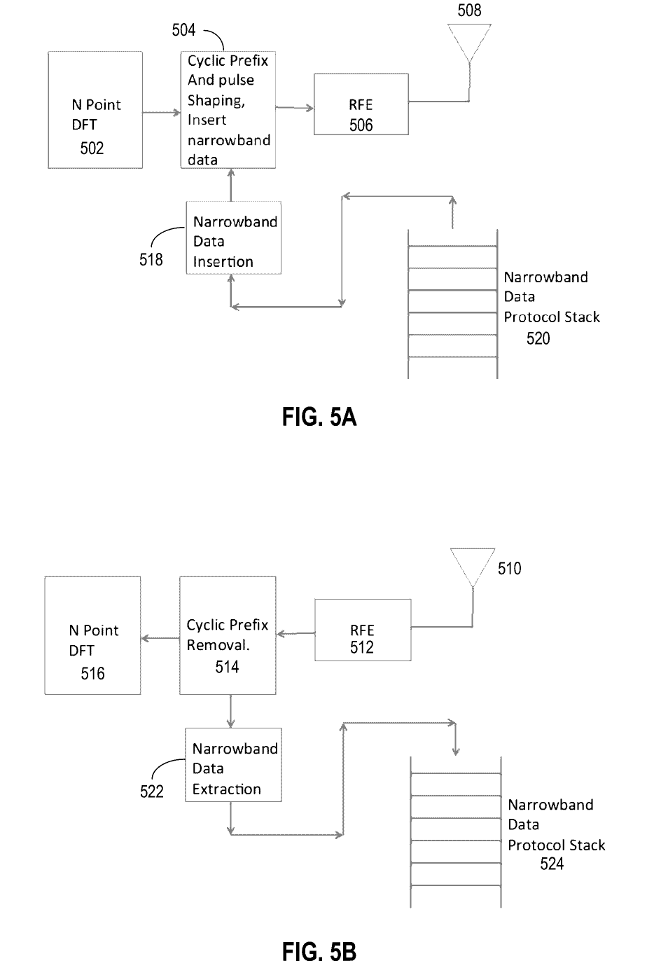

FIG. 6 illustrates how multipath delay can be computed in accordance with some embodiments described herein. A well-known pattern can be sent in the symbol, where the last section of the symbol, the one that needs to be copied over to the cyclic prefix, is clearly different from rest of the symbol. The UE device sees the symbol as a summation all the symbols as they arrive at UE. As shown in FIG. 6, the UE receives symbol 602 which was sent by the eNB and it also receives time delayed symbol 604 which may have been reflected one or more times before being received by the UE.

In the normal case, UE will extract the symbol because the cyclic prefix ensures that multipath delay is accounted for. However, in some embodiments described herein, the symbol is known, therefore the UE can calculate the maximum multipath delay experienced at that site. This delay value can be computed and reported to the eNB in a control message.

The eNB can send this type of control message infrequently, one every few hours. This allows the eNB to dynamically estimate the multipath delay for that cell site. The eNB can then calculate the amount of “stolen” time slot in the cyclic prefix based on the multipath delay estimation, and it can then position the “stolen” timeslot differently if need be.

Once the duration of the “stolen” time slot and the location of the “stolen” time slot is known, this information can be conveyed to the narrowband IoT UEs. In one embodiment, when the IoT devices come on the network, the size and location of the “stolen” time slot can be conveyed via msg4 described in reference to FIG. 4B. In addition, the size and location of the “stolen” time slot can be advertised frequently enough so that IoT UE devices get this information in time.

Embodiments described herein can be applied to TDD, FDD and Carrier Aggregation. Most of the current bands use FDD. In FDD, the downlink and uplink frequency bands are different. In addition, these bands are of equal width. For example, for a 5 MHz LTE band allocation, there will be 5 MHz for uplink and 5 MHz for downlink. This frequency organization has an inherent limitation that can be overcome by embodiments described herein.

As explained above, existing LTE traffic is usually asymmetric. Specifically, the downlink traffic is much more than the uplink traffic. For example, if user desires to watch a YouTube video, then uplink traffic consists of sending a universal resource locator (URL), which is typically less than 1 KB. However, the downlink traffic is typically several MB. Similar asymmetric traffic behavior exists for other use cases such as Google searches, Map browsing etc.

Unfortunately, the existing LTE frequency allocation does not account for the fact that the IoT traffic can be asymmetric. In contrast to existing frequency allocation strategies, some embodiments described herein can allow IoT devices to transmit more uplink traffic in CP symbols.

The traditional TDD approach to aggregation presents a different problem. As the name suggests, the traditional TDD approach involves taking turns. Specifically, the base station (e.g., an eNB) can transmit in one time slot, and all the UEs are given next timeslot to transmit. There are two major difficulties for applying this kind of aggregation. First, the transmit and receive timeslots cannot be literally next to each other. There has to be a small “quiet” period for transmitters to turn themselves off, plus the transmitted data to reach the destination. The required quiet period results in bandwidth wastage.

Second, TDD allows the transmit and receive time slots to be “adjusted” so that one has larger chunk. This is an advantage because the downlink traffic can be given bigger time slot than uplink. This works well, except that all the neighboring cell sites need to be configured “exactly the same way” to allow roaming. This poses a challenge to the operators. In addition, operators have to create buffer cells if they need to transition to cells with different timeslot allotments. Typically these buffer cell sites lose half of their capacity. Therefore again, this results in bandwidth wastage. Embodiments described herein overcome the above-described difficulties that are inherent in TDD.

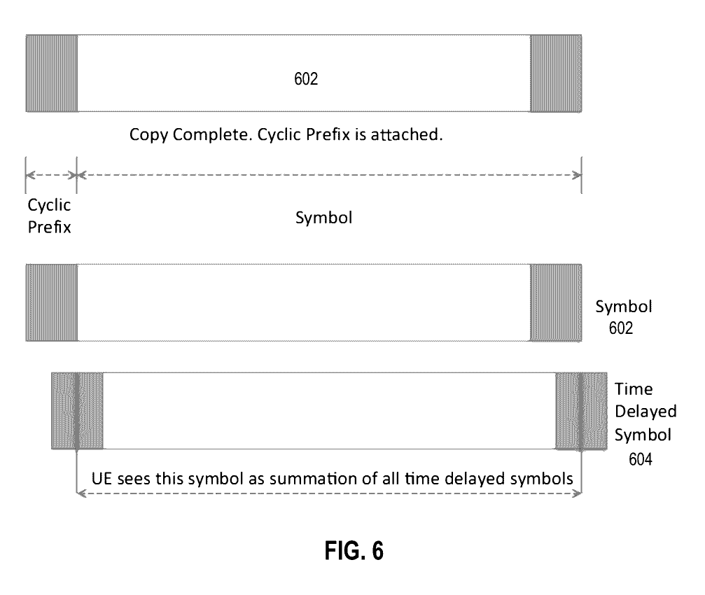

FIG. 7 illustrates an approach for carrying uplink and downlink traffic in accordance with some embodiments described herein. As shown in FIG. 7, the downlink traffic time slot and uplink traffic timeslots need to be separated by a quiet period. The downlink and uplink time slots can be adjusted for a given cell site. However all its neighboring cell sites must use the same time slots.

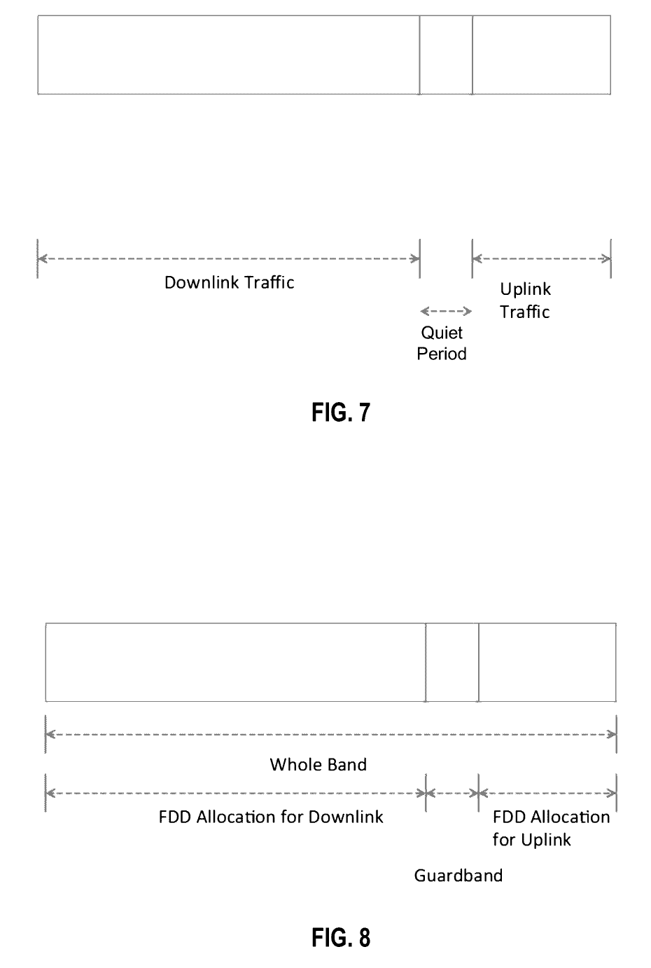

One approach to overcome the above-described TDD issue is to simply split the frequency band, and use the band as FDD. The band need not be split in the middle. FIG. 8 illustrates an approach for carrying uplink and downlink traffic in accordance with some embodiments described herein. Note that, in FIG. 8, the band has not been split equally for carrying downlink and uplink traffic. As shown in FIG. 8, the TDD spectrum can be split so that it can be used as two FDD spectrums. However, a guard band needs to be inserted in the middle. As described earlier, some embodiments described herein can be effectively used in this scenario. Specifically, the TDD band can be split into two unequal FDD bands, and most or all of the guard band can be used to carry narrowband IoT traffic.

The Voice over LTE (VoLTE) problem has been addressed in various ways in existing systems. Some embodiments described herein are based on an approach that is very different from the existing approaches. Specifically, the “stolen” time slots from the cyclic prefixes can be used to encode Voice information. This effectively obviates all other VoLTE approaches because the voice can be simply sent over the Guard Symbols.

Finally, note that Carrier Aggregation has no impact on embodiments described herein because these embodiments work well with or without carrier aggregation.

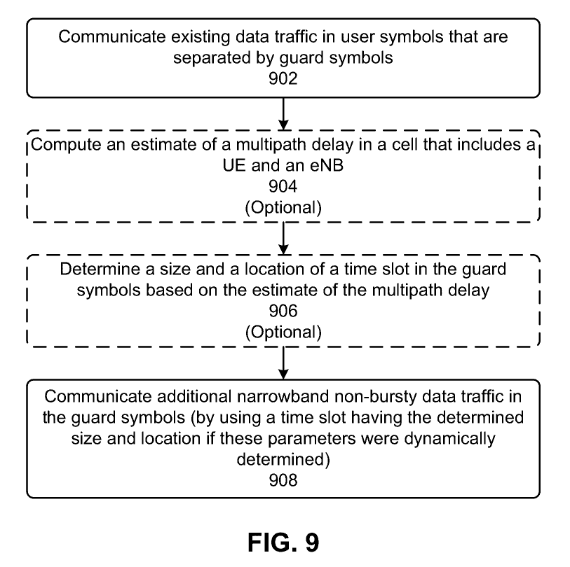

FIG. 9 illustrates a process for communicating additional narrowband non-bursty data traffic in a 4G/LTE network in accordance with some embodiments described herein. The process can begin by communicating existing data traffic in user symbols that are separated by guard symbols (operation 902). Next, the process can optionally compute an estimate of a multipath delay in a cell that includes a UE and an eNB (operation 904). The process can then optionally determine a size and a location of a time slot in the guard symbol based on the estimate of the multipath delay (operation 906). The size and location within the guard symbol can be communicated to the UE device every so often. Next, the process can communicate the additional narrowband non-bursty data traffic in the guard symbols (operation 908), e.g., in the time slot having the determined size and location. In some embodiments the time slot can be configured by the network operator instead of being dynamically determined.

The above description is presented to enable any person skilled in the art to make and use the embodiments. Various modifications to the disclosed embodiments will be readily apparent to those skilled in the art, and the general principles defined herein are applicable to other embodiments and applications without departing from the spirit and scope of the present disclosure. Thus, the present invention is not limited to the embodiments shown, but is to be accorded the widest scope consistent with the principles and features disclosed herein.

The data structures and code described in this disclosure can be partially or fully stored on a non-transitory computer-readable storage medium and/or a hardware module and/or hardware apparatus. A non-transitory computer-readable storage medium includes all computer-readable storage mediums with the sole exception of a propagating electromagnetic wave or signal. Specifically, a non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media, now known or later developed, that are capable of storing code and/or data. Hardware modules or apparatuses described in this disclosure include, but are not limited to, application-specific integrated circuits (ASICs), field-programmable gate arrays (FPGAs), dedicated or shared processors, and/or other hardware modules or apparatuses now known or later developed.

The methods and processes described in this disclosure can be partially or fully embodied as code and/or data stored in a non-transitory computer-readable storage medium or device, so that when a computer system reads and executes the code and/or data, the computer system performs the associated methods and processes. The methods and processes can also be partially or fully embodied in hardware modules or apparatuses. Note that the methods and processes can be embodied using a combination of code, data, and hardware modules or apparatuses.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for communicating additional narrowband non-bursty data traffic in a 4G/LTE network, wherein the additional narrowband non-bursty data traffic is generated by one or more internet of things (IoT) devices, the method comprising:
communicating existing data traffic in user symbols that are separated by guard symbols; and
communicating the additional narrowband non-bursty data traffic generated in the guard symbols.

2. The method of claim 1, wherein the guard symbols are used in the 4G/LTE network to prevent corruption of the user symbols by multipath reflections.

3. The method of claim 2, wherein said communicating the additional narrowband non-bursty data traffic data in the guard symbols comprises:
computing an estimate of a multipath delay in a cell that includes a user equipment (UE) and an evolved Node B (eNB);
determining a size and a location of a time slot in the guard symbol based on the estimate of the multipath delay; and
communicating the additional narrowband non-bursty data traffic data in a time slot having the determined size and location in the guard symbols.

4. The method of claim 2, wherein the UE is an IoT device.

5. The method of claim 4, wherein the IoT device periodically sends sensor data to the eNB.

6. The method of claim 1, wherein resources for communicating the additional narrowband non-bursty data traffic are allocated using a second protocol stack that is distinct from a first protocol stack that is used for allocating resources for communicating the existing data traffic.

7. A user equipment (UE) for communicating additional narrowband non-bursty data traffic in a 4G/LTE network, wherein the additional narrowband non-bursty data traffic is generated by one or more internet of things (IoT) devices, the UE comprising:
circuitry to communicate existing data traffic in user symbols that are separated by guard symbols, comprising:
a discrete Fourier transform (DFT) circuit to encode and decode the existing data traffic to and from, respectively, the user symbols;
a cyclic prefix circuit to create the guard symbols;
a radio frequency (RF) transceiver; and
an antenna; and
circuitry to communicate the additional narrowband non-bursty data traffic in the guard symbols, comprising:
narrowband data circuit to (1) insert the narrowband non-bursty data traffic into the guard symbols and (2) extract the narrowband non-bursty data traffic from the guard symbols; and
a processor to process control traffic communicated over the guard symbols by using a narrowband data protocol stack.

8. The UE of claim 7, wherein the guard symbols are used in the 4G/LTE network to prevent corruption of the user symbols by multipath reflections.

9. The UE of claim 8, wherein the UE is an IoT device.

10. The UE of claim 9, wherein the IoT device periodically sends sensor data to the eNB.

11. An evolved Node B (eNB) for communicating additional narrowband non-bursty data traffic in a 4G/LTE network, wherein the additional narrowband non-bursty data traffic is generated by internet of things (IoT) devices, the eNB comprising:
circuitry to communicate existing data traffic in user symbols that are separated by guard symbols, comprising:
a discrete Fourier transform (DFT) circuit to encode and decode the existing data traffic to and from, respectively, the user symbols;
a cyclic prefix circuit to create the guard symbols;
a radio frequency (RF) transceiver; and
an antenna; and
circuitry to communicate the additional narrowband non-bursty data traffic in the guard symbols, comprising:
narrowband data circuit to (1) insert the narrowband non-bursty data traffic into the guard symbols and (2) extract the narrowband non-bursty data traffic from the guard symbols; and
a processor to process control traffic communicated over the guard symbols by using a narrowband data protocol stack.

12. The eNB of claim 11, wherein the guard symbols are used in the 4G/LTE network to prevent corruption of the user symbols by multipath reflections.

13. The eNB of claim 12, wherein the processor is configured to:
compute an estimate of a multipath delay in a cell that includes a user equipment (UE) and the eNB;
determine a size and a location of a time slot in the guard symbols based on the estimate of the multipath delay; and
communicate the determined size and location of the time slot to the UE.

14. The eNB of claim 13, wherein the UE is an IoT device.

15. The eNB of claim 14, wherein the IoT device periodically sends sensor data to the eNB.
